(19) United States
(12) Patent Application Publication
(10) Pub. No.: US 2004/0076139 A1
(43) Pub. Date: Apr. 22, 2004

(54) Wireless name service registry and flexible call routing and scheduling

(76) Inventors: Kenneth Kang-Yeh, Sierra Madre, CA (US); Anand Sethuraman, Sunnyvale, CA (US)

Correspondence Address: ANAND SETHURAMAN, 929 CARSON DRIVE, SUNNYVALE, CA, 94086, US

(21) Appl. No.: 10/619,942

(22) Filed: Jul. 15, 2003

Related U.S. Application Data
(63) Continuation-in-part of application No. 09/609,904, filed on Jul. 3, 2000.

(51) Int. Cl. H04J 3/24; H04L 12/66

(52) U.S. Cl. 370/349; 370/352

(57) ABSTRACT

A method enabling a wireless telephone or other communication device to enter a unique/generic string identifier such as an e-mail address. When entered on the communication device, a Wireless Name Service (WNS) Server is contacted. The WNS server responds to the communication device with information that is associated with the string identifier in a WNS Registry. The WNS Registry may contain data elements that are returned based upon the application of optional rules to the circumstances of the call.

### RELATED APPLICATIONS

This application is a continuation-in-part of patent application Ser. No. 09/609,904 filed on Jul. 3, 2000, entitled “Wireless Name Service”

### 1. FIELD OF THE INVENTION

The invention relates generally to wireless telephony. More specifically, the invention relates to directory and routing mechanisms for wireless telephony.

### 2. BACKGROUND

Wireless telephony devices such as cellular telephones utilize a service provider's network to place and receive phone calls and, in recent vogue, download informative data such as stock quotes, news, etc. Once placed into service (i.e. activated for use), a wireless telephony device is assigned by a seven or ten (including three-digit area code) telephone number. This number will remain while the user retains the same service provider. Often, however, due to changes in technology, dissatisfaction with quality of service, changes in pricing, and so on, a user will change their service provider. The change in service provider, even for the same geographical area, will yield in a new cellular telephone number.

Additionally, cellular telephone numbers are often kept private for security reasons and to prevent unauthorized cold-calling. Due to their changing nature and privacy concerns, they are not published in any directory which is accessible to others. Further, there is no operator-provided directory assistance for such numbers. Even where such directories and assistance are available for traditional wire-based (POTS-Plain Old Telephony Service) telephone numbers, printed directories or those published on the Internet, are often not updated with much regularity. Further, the user/building whose number is being indexed is not allowed to provide input when that POTS number changes as it does when the user moves residence. Thus, today's printed directories are sometimes out-of-date with regard to a particular user. Even those published online are derived from static listings that may be six or more months old by the time they are published, and thus are also out of date. Corporate changes in telephone numbers, extensions and locations of employees is often even more pronounced.

Further, telephone numbers are difficult to memorize for many. For this reason, cellular and PSTN-based telephones have both been equipped with memory storage so that frequently called numbers may be recalled. Cellular telephones have the added advantage of showing names associated with phone numbers and of allowing search and recall by the name of the person rather than the number. Another advantage is that cellular telephones can store the number from an incoming or outgoing call with a few keystrokes. Even with such features, it may be desirable to replace the paradigm of telephone “numbers” and even, of people's names, as a means of identifying, since names may not be unique and cellular numbers change. It may also be desirable to have a single, unique point of reference with which to store and collect a variety of information about a user, one that can be easily updated, controlled for privacy and accessed from anywhere without substantial cost or complexity.

### SUMMARY

The invention enables a wireless telephone or other communication device to enter a unique string identifier such as an e-mail address. When entered on the communication device, a Wireless Name Service server is contacted. The WNS server responds to the communication device with a telephone number that is associated with the string identifier in its database. This telephone number may then be used to place a call on the communication device by a variety of methods.

The invention further includes a registry for associating the unique string identifier with information such as additional telephone numbers, address, demographic and biographic information etc. The WNS registry is a database or collection of databases by which the owner of the unique string identifier can access and modify information records related to the owner. The owner can update or add information to their WNS registry record as suits them.

The registry also includes the capability for owners to create white lists and black lists which will allow and deny calls placed to their WNS identifier. The white lists and black lists can be created by the user and may be dynamic and/or static in nature. White lists and black lists can also be updated by some automated mechanisms as well, such as accessing other data sources and downloading contact information of desired callers.

The registry also includes a service for flexible call routing and scheduling which would be, in at least one embodiment, rule-based in nature. Call routing would enable the owner of a unique string identifier to specify what device (telephone number, cell number, email address, pager etc) calls are to be routed to. As mentioned, rules can specify that certain calls from certain individuals be directed to one number while other calls may be directed to another number. Scheduling calls in accordance with time/date or event triggers is also the subject of various embodiments of the invention. A rule may specify that from time A to time B, calls go to telephone number X while calls originating from time B to C go to telephone number Y. This enables full flexibility in the handling of information routing to devices such as cellular telephones, PDAs, pagers, landline telephones and other information devices. Combining caller ID services, rules may be established by the owner that enable a service provider to route calls on a customized, personalized basis. For instance, one rule might block all calls originating from a certain prefix code such as “800”.

### BRIEF DESCRIPTION OF THE DRAWINGS

The objects, features and advantages of the method and apparatus for the present invention will be apparent from the following description in which:

FIG. 1 is a system diagram according to one or more embodiments of the invention.

FIG. 2 is a flowchart of communication via Wireless Name Service technology as presented in one or more embodiments of the invention.

FIG. 3 is an illustration of a table utilized in a Wireless Name Service Server.

FIG. 4 illustrates an environment implementing a WNS solution as set forth in various embodiments of the invention.

FIG. 5 illustrates a standard WNS call procedure according to at least one embodiment of the invention.

FIG. 6 illustrates WNS query formulation according to at least one embodiment of the invention.

FIG. 7 illustrates indexing into the WNS Registry to return data elements according to one or more embodiments of the invention.

### DETAILED DESCRIPTION

Referring to the figures, exemplary embodiments of the invention will now be described. The exemplary embodiments are provided to illustrate aspects of the invention and should not be construed as limiting the scope of the invention. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware or combinations thereof.

The wireless name service, which is the subject of one more embodiments of the invention, delivers telephone numbers and other information based upon the e-mail address of the target user. The e-mail address has many advantages over names and numbers. E-mail addresses are always, by definition, unique unlike names. E-mail addresses, unlike telephone numbers and addresses and even names (of people changing their name due to marriage), often never change because business and casual users use the e-mail address as a permanent point of contact, and thus the user is unlikely to change it. E-mail addresses are easier to memorize than numbers and even, first and last names, since these can be more easily confused and transposed. E-mail addresses often identify a geographical place, profession or name of business in its server name identifier, and thus can be more easily be associated. For instance, if a user want to contact someone at a business named XYZ, Inc. whose name is John, his e-mail address may be john@xyz.com. This is much easier to remember than “331-456-7612” which may be telephone number or even his name, since there may be many with the first name “John” known to the user.

To attain these advantages, the wireless name service defines both a method of transferring telephone numbers and a method of indexing them. At some server machine, a database is maintained which relates for each record a unique primary key consisting of an e-mail address string to at least one number such as the cellular telephone number. On a wireless device or even a computer telephony device, the input by entering, speaking or clicking on (through some activation means) a string representing the e-mail address will trigger a response from the server sending the cellular telephone number back to the device. The means of responding with the cellular telephone number may be WAP (Wireless Application Protocol) in the case of the device being wireless. In the case of the device being a computer system or other information device, HTTP (Hypertext Transport Protocol) may be used. Where privacy of the actual digits of the telephone number is important to preserve, the response may be encrypted, scrambled or transferred directly into the dialing mechanism of the device so that the user of the device never sees the actual digits. On phones that do not have WAP, the service provider could provide a channel for transferring the number associated with the e-mail address through SMS (Short Message Service) or any of the other many control and data channels available to it.

Whatever the input, data transport mechanism or the dialing mechanism, the fundamental concept is the triggering of telephone number information by using the e-mail address of the call recipient as the triggering key. In one embodiment of the invention, a wireless internet calling device (WIC) with a connection to the Internet can access a WNS (Wireless Name Service) server to retrieve/return a telephone number stored in a record by accessing the primary key (memory address) of an e-mail address. With the number retrieved, the WIC can automatically place the call and/or store the number for future use. Where more than one number is available for a given e-mail address key, meaning that the user assigned to the e-mail address has more than one listed phone number, the WIC will device will receive each number in turn until a connection is established. In one embodiment of the invention, there may one or more centralized WNS servers that contain mappings for an entire e-mail address. In yet another embodiment, the WNS can be distributed across the providers of the e-mail addresses themselves. Thus, in the exemplary e-mail address “john@xyz.com”, a WNS server for “xyz.com” may be contacted to attain the telephone number associated with user “john”. A distributed WNS server may also allow quicker and more efficient implementation of a private corporate intranet directory system that focuses on users and departments as the trigger for telephone numbers, extensions, etc.

While the name “wireless Name Service” has been applied to describe this invention, in many other embodiments, the information returned may be PSTN telephone numbers, physical addresses or any number of data and documents. Also, while the name “Wireless Name Service” implies that access is by wireless devices, non-wireless devices (such as a personal computer) can use the same mechanism, perhaps with greater effectiveness, to access information. For instance, the personal computer may be programmed to call/ping the WNS server(s) upon the clicking of an e-mail address in any application. The WNS has thus the potential of eliminating the concept of dialing a phone number that is associated with Internet-based telephony. While the computer, may, like certain wireless access devices, store a list of names and associated numbers, these static lists can be replaced altogether or periodically enhanced by verifying the accuracy and current-ness of the information in the list.

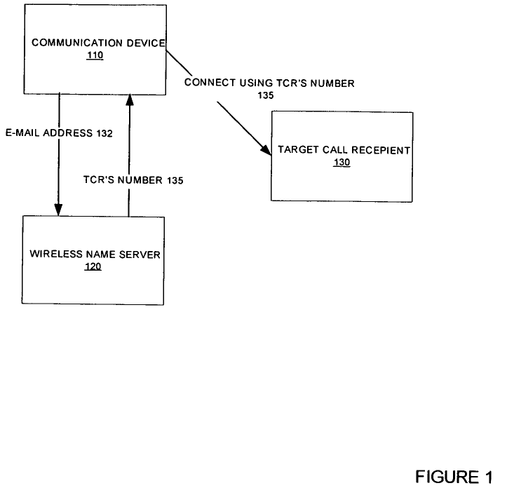

FIG. 1 is a system diagram according to one or more embodiments of the invention.

A Communication Device 110 such as a cellular telephone or Internet telephony device or other telephony capable system may utilize the wireless name service to contact automatically or retrieve the telephone number of any other communication device. In one embodiment of the invention, the e-mail address 132 that belongs to or is associated with a Target Call Recipient 130. The caller that uses Communication Device 110 can input e-mail address 132 (through input means such as voice, keyboard, mouse click etc.) into the Communication Device 110. This e-mail address 132 is then transmitted to a Wireless Name Server 120 which is a database, table or other information store that contains a telephone number related to that e-mail address 132. To enable this, the Target Call Recipient 130 will have within the Wireless Name Server 120, an entry that relates the e-mail address 132 with the TCR's (Target Call Recipient's) number 135.

This relationship between e-mail address 132 and TCR's number 135 is maintained in advance of the call pictured in FIG. 1. The Wireless Name Server 120 may store many such e-mail addresses along with a telephone number for each. In addition, as will be described in greater detail below, other information in addition to the telephone number of the Target Call Recipient may be stored on the Wireless Name Server. The key trigger for retrieving such information is the use of an e-mail address.

In response to the e-mail address 132, the TCR's Number 135 is transmitted from the Wireless Name Server 120 to the communication device 110 using WAP or SMS or other appropriate service/protocol. Once the TCR's number 135 is received by communication device 110 then the call is ready to be connected. In one embodiment, the number 135 is displayed in the display area of the communication device 110 and then can be automatically dialed so that communication device 110 may connect with the Target Call Recipient 130. Also, the number 135 thus received could be stored in a directory or memory of the communication device 110.

In another embodiment of the invention, the actual digits of number 135 is not displayed anywhere on the communication device 110, but may be transmitted from Wireless Name Server 120 directly into an internal memory of communication device 110 so that it is dialed, but not displayed thereon. In yet another embodiment, the number may appear in a scrambled or encrypted code so that the actual number is not displayed, nor transmitted in its true form. In such embodiments, it may be possible for the Target Call Recipient 130 to specify whether the number should be displayed to the communication device 110. The Target Call Recipient 130 will typically be a cellular telephone, but may also be another telephony device such a facsimile, pager, or POTS telephone.

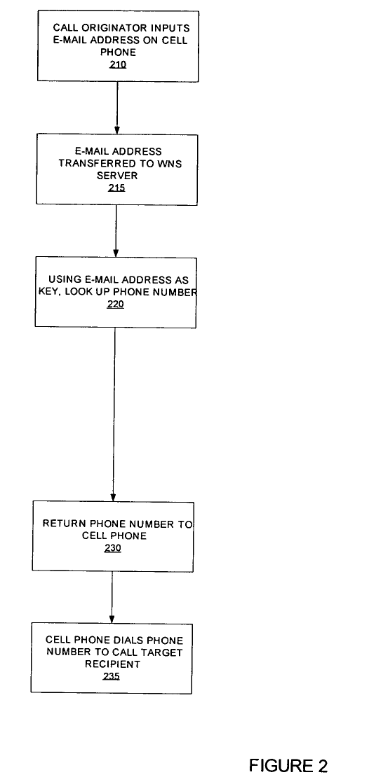

FIG. 2 is a flowchart of communication via Wireless Name Service technology as presented in one or more embodiments of the invention.

First, the call originator (one who wishes to place a call) inputs an e-mail address on their cell (cellular) phone (block 210). The input may be achieved by voice (i.e. speaking or spelling out of the e-mail address) or through the input keys of the cell phone or by a selecting of the e-mail address which may be in a list or directory. The input e-mail address is then transferred to a WNS (Wireless Name Service) Server (block 215). Using the e-mail address as a key (index address), the WNS server looks up the phone number in the same row of the table indexed by the e-mail address (block 220). The WNS server then returns the phone number to the cell phone (block 230). The cell phone then uses the phone number returned from the WNS server to call the target recipient that the user of the cell phone wishes to connect with (block 235). The cell phone may also be automatically connected to the target via a switching device, which receives the number instead of the cell phone and then connects to the target on its behalf.

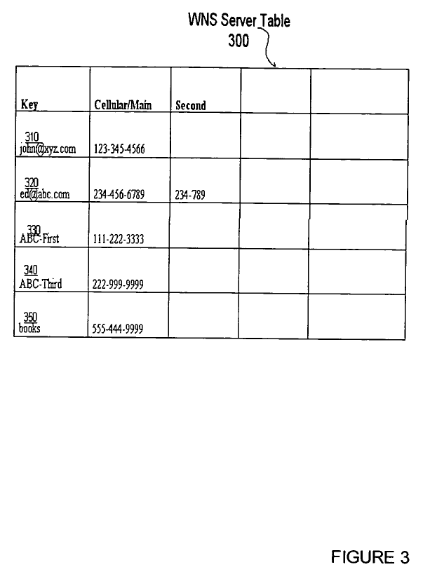

FIG. 3 is an illustration of a table utilized in a Wireless Name Service Server.

FIG. 3 shows a Wireless Name Service (WNS) Server Table 300 that may be embedded or stored into a database or flat file or other data storage mechanism. The WNS Server storing Table 300 may be accessible via IP (Internet Protocol) or through touch tone signals such as DTMF (Dual-Tone Multi-Frequency) which are available to most telephone systems. The Table 300 is indexed and addressed by a Key field which consists of e-mail addresses and may also consist of keywords, or names of businesses.

Table 300 shows a first entry that has as its key field 310 the e-mail address string “john@xyz.com”. When “john@xyz.com” is detected as an input to the WNS server, the WNS Server matches the string with the Key field. After a successful match, the WNS Server retrieves the phone number in the “Cellular/Main” column intersecting the row for the Key “john@xyz.com”. According to Table 300, the retrieved phone number for the e-mail address “john@xyz.com” is “123-345-4566”. In one embodiment of the invention, the retrieved number “123-345-4566” is returned to the device that originated the look-up by sending the e-mail address. In another embodiment, the retrieved number “123-345-4566” may be first scrambled/encrypted or sent without displaying it on the device. In another embodiment of the invention, other information related to the owner of the e-mail address “john@xyz.com” may also be sent to the device originating the input of the e-mail address to the WNS server. Entry 310, for example, also has the e-mail address owner's name “John Jetson”, which may be sent along with the listed number. This information may thus be automatically downloaded into the information device upon that device sending the simple string “john@xyz.com” as a key.

The advantage of using e-mail addresses as a key to the information in the WNS server is that e-mail addresses are by definition, strings that uniquely identify one person or entity without possibility of repetition. While there may be two persons with the name “John Jetson”, only one such persons have the e-mail address “john@xyz.com”. Having knowledge of this e-mail address can allow a communication device to connect to the telephone of “john@xyz.com” in an automated fashion. Further, the e-mail address may be used to retrieve a multitude of information such as an e-mail holder's name, address, job title, company, etc. The entry having “ed@abc.com” as its key 320 may when retrieved return the phone number “234-456-6789” as well as a secondary telephone number “234-789-9876”, the name of the e-mail address hold “Ed Eddie” and the address of “111 Main Street”. This differs from many other directory services in that the uniqueness of the string is guaranteed by the database requirement imposed upon server Table 300 that all primary keys be unique when their entries are created.

Corporations or institutions may have valuable information stored on the WNS server for retrieval by a handheld communication device, cellular phone or other such device. Table 300 shows the example of ABC, Inc., a company with two branch locations. The information for the first of these locations is contained in an entry whose Key 330 is “ABC-First”. Comparing this key with the Key 340 indexing the second of the ABC, Inc. branch locations “ABC-Third”, these keys are different when compared in their entirety. While each of these entries has the same Name field “ABC, Inc.”, their addresses and phone numbers are different. The second branch location has its address at “333 Third Avenue” and thus, was assigned a Key 340 of “ABC-Third” in order to indicate its location. Likewise, the first location indexed by Key 330 is “ABC-First” to indicate its address on “111 First Avenue”. Each Key is unique and does not have to be an e-mail address but may be a place locator or other identifier that indicates some unique property about the entity. Thus, when “ABC-First” is transmitted from a communication device to the WNS Server, a look-up of Table 300 would return the phone number “111-222-3333”. When “ABC-Third” is transmitted from a communication device to the WNS Server, a look-up of Table 300 would return the phone number “222-999-9999”. The designation of Keys shown is merely exemplary, but each Key in a given WNS table should be unique.

Place.names and company names are some of among the many types of strings that may be used as Keys for phone number/information entries. Another form of a indexing Key refers not to the specific but to the general. Keywords, such as books, CDs, music, etc. may be used to identify specific stores, companies, services, etc. uniquely. WNS Server Table 300 shows a keyword Key 350 “books”. Thus, when a communication device sends the string “books” to the WNS server, the number “555-444-9999” of “Bookstore” would be returned to the communication device allowing the user to connect, store or view that phone number.

Keywords as a Key may be reserved like any other unique string such as an e-mail address. A given keyword may refer to only one entity such as the “Bookstore” with phone number “555-444-9999”. However, the entity Bookstore may reserve for its use more than one Key, such as “book” or “text” in addition to “books”.

Another aspect of the invention is the establishment and use of a Wireless Name Service (WNS) Registry. The WNS Registry is a database or collection of databases or files which can be part of or accessed by a WNS Server. The WNS Registry stores the unique string identifier and its corresponding associated telephone number. A unique string identifier may also be associated with a record that contains a plurality of telephone numbers, for instance, a home telephone number, a cell number and a work phone number. Once created, this record may be created, updated or deleted by the owner of the unique string identifier. The owner would access an interface for accessing the WNS registry and then through the use of forms or other mechanisms, update the information contained in their record.

The owner's record may also contain other personal information such as his mailing address, fax number and other such contact information. Optionally, the owner's record may contain biographical or demographical information such as age, sex, race, interests and so on which may be of use in profile matching or marketing. In one embodiment of the invention, the owner would have full control of the content and access to the owner's record. In other embodiment's where an owner's record is given by or maintained by an organization such as the owner's employer, such control and access may be shared.

Below is a sample set of two owner records in a WNS registry:

| Unique ID (Key) | Field Name | Data | Access Level |
|---|---|---|---|
| john@xyz.com | Name: | John Jetson | Public |
| | Address: | 123 East St. | Private |
| | Zip: | 99999 | Private |
| | Cell Number: | 123-345-4566 | Keyed |
| ed@abc.com | Name: | Ed Eddie | Public |
| | Address: | 111 Main St. | Public |
| | Zip: | 88888 | Public |
| | Cell Number: | 234-789-9876 | Keyed by rule |
| | Home Number: | 555-666-7777 | Keyed by rule |
| | Age: | 33 | List |

In the above exemplary Registry, the key “john@xyz.com” and “ed@abc.com” refer to two owners John Jetson and Ed Eddie, respectively. These owners may create their records and add to or modify the information contained therein. For instance, a website may be accessed by potential record owners allowing them to create their WNS Registry record and allowing them to create a user account that is password protected for future use. Any security mechanisms such as HTTPS or other encryption can be used to ensure privacy on such a website. Further the data in the WNS Registry may itself be encrypted. Such security and encryption technology (for instance, SSL, PGP etc.) is well-known in the art and not a subject of the invention except as needed in implementing various embodiments of the invention.

The owner records contain an “Access Level” column which associates each data element in a record with what kind of access is afforded it. The Access Level types shown above are: Public, Private, Keyed, Keyed by Rule and List. These are merely exemplary of the kind and number of Access Levels that may be used or chosen and is not intended to be limiting. “Public” would indicate that the corresponding data element can be accessed by anyone who uses the unique ID/key in their information device. “Private” would indicate that the data element not be released to anyone. “Keyed” indicates that the data element is directly retrieved by the WNS server and returned to the communications/information device which initiated the unique ID entry. “Keyed by Rule” indicates that the data element is keyed but only conditionally so based upon a predefined rule (see below). “List” indicates that the data element be accessible by anyone who is in the include or allow list for that data element or for any such “List” type data elements in the record. Alternatively, “List” could refer to a list of devices/entities/people to which access to the data element be denied rather than allowed.

Rules for Keying of information in a WNS Registry can be based on any combination of time, date, location of the device originating the call/information request, identity/owner of the device originating the call, and so on. Thus, the cell phone number of Ed Eddie can be Keyed by the unique ID ed@abc.com during the hours of 9-5 while the home telephone number can be keyed by the same ID ed@abc.com during other hours. This rule can be created/stored in the owner's record and modified as desired, or expanded upon. A call can thereby “routed” by the application of the rule to the circumstances surrounding the call.

Many such rules for call routing can be employed, including those that are based on the origination of the call. The origination of the call can be discovered through caller ID or similar mechanisms which will identify the device which originates the incoming call. The identity (such as originating call telephone number) can be matched against a rule associated with the record or against a white list or black lost so that the routing of the call can be determined. The “List” Access Level is the logical equivalent of a rule that matches the identity of an originating call and compares it with a list of allowed callers (or blocked callers). Caller ID functionality, as it currently employed by telephone and carrier systems, is well-known in the art. The ability to use this information once obtained and customize a calling experience is one of many aspects of the invention.

Location or origination based rules may also user area codes and prefix codes in order to determine the routing of calls. For instance, the “310” area code as an originating telephone number may trigger a rule which sends such calls to the Los Angeles office of an organization, since 310 indicates, in general that the device originating the call is in or based out of the Los Angeles. In the case of cellular or mobile devices originating the call to a WNS name/ID, the location or origination information may additionally or alternatively include the actual physical location of the user of the device. For instance, in the case of cellular telephone which while having a 310 prefix number as its device telephone number, suppose the cellular telephone is in San Francisco, and thus out of the “310” geographical area. Then, an absolute location based rule can take advantage of the ability of a mobile device to be approximately located by its nearest cellular base station (tower) location or even more exactly, by GPS (Global Positioning System) in devices so equipped. The absolute location rule may instead route the same call to the San Francisco office of the same company rather than the Los Angeles office, even though the area code of the device indicates a Los Angeles origin. With land-line telephone originated calls, absolute and device-relative location rules become logically identical.

Automatic routing of calls is enabled by the use of a WNS Registry and affixing desired rules thereto. It could enable large organizations to eliminate the distribution and publication of different telephone numbers. For instance, a WNS identifier like “ABC Customer Service” would automatically find the telephone number for customer service of the ABC company while “ABC Media” would find and return the telephone number of the media relations department. WNS names and IDs can be interpreted even if not exactly matching. For instance, someone entering or saying “ABC Customer” would match the closest entry in the WNS Registry or “ABC Customer Service”. Any number of neural network/artificial intelligence and data disambiguation technologies may be utilized to enable partial or inexact and approximate WNS names to return valid and accurate data elements (e.g. telephone number or address). WNS names/IDs may also be generically input and then trigger a location-based disambiguation rule. For instance “ABC” when input from a device having an absolute location in Los Angeles may trigger a location-based rule for routing the call to “ABC Los Angeles”

When used on a device such as a cellular telephone, the need for entering telephone numbers may be reduced or even eliminated entirely. Further, current directory services such as “411” which often require a live operator or the assistance of a full yellow/white pages and complicated queries/lookups (either manual or electronic) to yield results could be replaced or enhanced by utilizing WNS IDs and retrieving the information directly into the device or telephone.

One important aspect of the invention in this regard in the elimination of operator assisted call routing or switching. Calls can be automatically connected via the mobile or land-line communications/information device since the telephone number is directly downloaded thereto. Likewise, with information such as address or directions to a building, such information can be retrieved via the WNS server and downloaded directly onto the device with the keying of the appropriate WNS Registry ID/name or even phrase.

In this regard, the “uniqueness” of a WNS name/ID/phrase can be local or global or region based. In addition, a WNS name as input may be generic and then disambiguated as mentioned herein. An e-mail address is an example of a globally unique WNS ID. “John Jetson” may be a name in the contact list of a cellular telephone which is locally unique (and perhaps, but not necessarily globally unique) and once the correct WNS unique ID is associated with the locally unique “John Jetson”, the WNS Registry record for john@xyz.com can be thereafter associated with that locally unique name “John Jetson” (as might be stored in the contact list or phonebook mechanism of a cellular telephone).

Each WNS record can be as large as needed or desired by the owner (as long as enough storage is provisioned thereto) to store many different kinds of data or information. Text archives, voice message archives and contact lists can be stored with a WNS record for download and update. As will be discussed below, the use of WNS Registry allows contact information to be dynamic rather than static in nature. For instance, once a mobile device has “John Jetson” (locally unique but tied to the WNS Registry record for john@xyz.com) in its phonebook, the entry will never have to reprogrammed in the case of a change of the telephone number of John Jetson or updates to other WNS record data elements. On a cellular telephone, as will be described below, the selection of “John Jetson” from the phonebook will first contact the WNS Server. The WNS Server will then query the WNS Registry with john@xyz.com and return the Keyed or Keyed by Rule entry for that record. Provided that the WNS Registry has the latest or up-to-date telephone number, this telephone number will be returned to the mobile device placing the call, allowing the mobile device to then place the call through their service provider or carrier. This allows data entries in a mobile device with a static memory to be dynamic in result and eliminates the need for reprogramming. A single change by the owner of the record (or even, by the cellular telephone carrier) to the Keyed telephone number will be globally reflected for anyone who tries to contact John Jetson, instantaneously and automatically.

One feature enabled by a WNS Registry, as set forth in various embodiments of the invention, is the automatic population of white lists and automatic updating of and downloading of contact lists and contact information. Since many people have cell phones and contact lists in other application/devices such as on a PDA or in a contact manager application of a personal computer, the WNS Registry provides an interface to upload/download such information. Contact and cellular telephone Phonebook lists can be stored as an addendum to a WNS record. These contact lists can either be created and managed via the WNS Registry provided interface or managed/created elsewhere and imported into a WNS Registry record. Once stored, a brand new cellular telephone can contact the WNS server and the owner of the record can download his/her contact list into their new telephone, automatically populating it thereby. When switching from cellular telephone to another or opening a second cellular telephone line, the contact list of the old/previous telephone can be uploaded to the WNS Registry and then downloaded by the new telephone. This eliminates the need for programming/reprogramming and populating of cellular telephones. The dynamic nature of the data allows just the “names” (WNS names/phrases/unique IDs or combination thereof) to be downloaded and the remainder of the information to be dynamically obtained, if desired. Contact list synchronization and management is well-known in the art but has not been applied to mobile devices through a centralized dynamic data delivery mechanism. A contact list, if stored in a WNS record, can also be made live and dynamic. A WNS-stored contact list entry can link to other WNS records, making such entries automatically and in real-time connected to the original and true owner record associated with contact. They can thus be static or dynamic or a combination thereof depending upon owner preference and data availability (if the contact list entry does not have a corresponding WNS record entry). The dynamic linking of contact list names to WNS records can also be automated by a matching routine which matches data elements to other existing WNS owner records, and then selects the best fit or presents the owner of the contact list with a choice of several close matches.

In other embodiment of the invention, the mobile device can be made or utilized as a “thin” device. The entire phonebook list can be dynamically obtained from the WNS registry and server, if desired and in the case of devices with limited size/memory, this may in fact be desirable. In other embodiments, the mobile devices could download all of the contact information associated with its phone book of names or WNS names/IDs, with such information updated when calls are placed or updated upon demand or updated by the WNS server itself seeking owners of contact lists who would require the updated information and downloading such updates to them automatically.

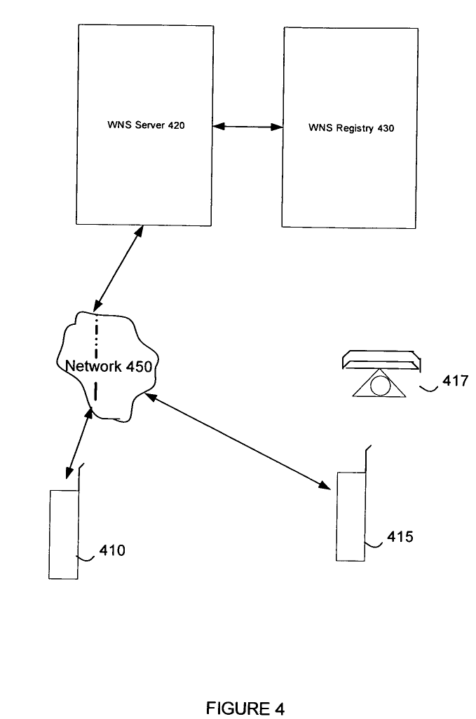

FIG. 4 illustrates an environment implementing a WNS solution as set forth in various embodiments of the invention. The user of a cellular or mobile telephone device 410 will initiate WNS by entering/selecting or speaking into device 410 a unique ID, a WNS name/keyword/phrase or locally unique ID. This input into device 410 is then communicated over a network 450 to WNS server 420. The communication from the device 410 can be through WAP or other web-enabled telephony data transport mechanisms which are supported by device 410 and its carrier or service provider. Further, mobile device 410 may be operating over any type of transmission mechanism, such as CDMA, GSM, satellite, etc. The communicating of data (whether voice or text) through wireless communication devices is well-known in the art and thus, will not be discussed in detail. Network 450, likewise, is not a subject of the invention, and may be any network or combination of networks (such as cellular, wireless, wire-line, satellite, etc.) required for the mobile device 410 to communicate with the WNS server 420.

Once the input from device 410 is communicated to the WNS server 420, the WNS Server 420 will then formulate a query to return information that is sought by the user of device 410. The formulation of the query is a process that utilizes information such as the input to device 410, as well as device information about device 410. Such device information includes, but is not limited to, the phone number of device 410, the approximate real geographical location of device 410, and any other command or flag (such as a request for address information). The process of formulating a query is discussed in further detail below.

Once the query is formulated the WNS Server 420 indexes into a WNS Registry 430 using a Globally Unique ID. The WNS Registry 430 finds the record associated with the matching Globally Unique ID. If there is no command associated with the query (i.e. the command is NULL), then Keyed (or Keyed by Rule) type data elements are to be returned by the query. If the data element in the corresponding record is keyed by a rule, then the rule is resolved on the WNS Server 420 and the appropriate data element(s) is(are) selected from the record in the WNS Registry 430. The data element(s) is then returned to the WNS Server 420 which then communicates the data element to the mobile device 410. If the data element is simply Keyed without any rule, it is automatically retrieved from the record stored in WNS Registry 430 and communicated to device 410 via WNS Server 420. If there is a command associated with the query then, other data elements, such as address information, may be retrieved from the WNS Registry 430 when the query is processed.

As an example, assume a potential recipient owns two telephones 415 and 417. Telephone 415 is a cellular telephone while telephone 417 is a land-line based telephone. Assume the recipient's name is Ed Eddie, and that the recipient's WNS record is as shown in Table 1 above. Telephone 417 would have the number specified in the “Home Number” field of Table 1 while telephone 415 would have the number specified in the “Cell Number” field. A user of telephone 410 would input (either by voice, key-coding or selection mechanism) “Ed Eddie” or the unique ID. In the case of the input being “Ed Eddie”, this would be associated with the unique ID within the device 410 itself. This associated unique ID would be communicated from device 410 to WNS Server 420. Alternatively, the input name “Ed Eddie” could be sent to WNS Server 420 and then disambiguated by a further query back to device 410 or by some artificial intelligence.

The WNS Server 420 would then index into the WNS Registry 430 to find the record for “Ed Eddie” (shown in Table 1 above). Assuming that no command (NULL) accompanied the input from device 410, then the “Keyed by Rule” data elements would need to be returned. To do so, a rule or rules associated with the record of Ed Eddie would be retrieved from the WNS Registry and then applied by WNS Server 420. For instance, assume the rule for Ed Eddie states that all calls originating on weekdays go his cell phone while all other calls (on weekends) go to his home telephone. If the call (input of Ed Eddie) from device 410 comes on a Saturday, then the WNS Server 420 will, based on this rule, select “555-666-7777” from the record in Registry 430 and return this data element to the mobile device 410. The mobile device 410 would then automatically place a call to the selected number and thus, device 410 and telephone 417 would be connected. If the call were to originate on a Wednesday, then the WNS Server 420 will, based on this rule, select “234-789-9876” from the record in Registry 430 and return this data element to the mobile device 410. The mobile device 410 would then automatically place a call to the selected number and thus, device 410 and telephone 415 would be connected. This exemplifies one aspect of “rule-based” call routing and scheduling. In the same way, if the record of Ed Eddie contains an associated black list which refuses to accept calls from mobile device 410, then the data element would not be returned and an error message might appear on mobile device 410. As described earlier, the actual digits of the number in the data element could be encrypted or scrambled so that the owner of the number has full control over calls incoming to them, and thus not actually be visible on device 410, whether the call is routed or denied. As described above, location-driven disambiguation rules can also be applied, if desired, to select between device 415 and device 417 when a call is placed from device 410.

With the use of WNS Registry 430, contact lists for the devices 410, 415 and even 417 can be maintained online or accessible by network connection. Mobile device 410 could for example, upload an initial set of stored phone book entries, which could then be maintained and updated via web or other interface to WNS Registry 430. Through web or other interfacing, the WNS Registry records of owners could be maintained by these owners directly, with rules, data elements and Access Levels modified as desired. Organizations can also use such a Registry 430 to control routing of calls to different offices, departments, divisions, etc. When a contact list is stored in the WNS Registry 430 entries therein can be automatically or manually linked to other WNS records so that information stays up-to-date. Further, such lists may also be useful in creating special rules which route calls based on identity. For example, calls from John Jetson go my cell phone, while calls from Ed Eddie go to my home phone. Once stored, a new telephone can retrieve and download contact lists from the WNS Registry to automate the population of its phone book.

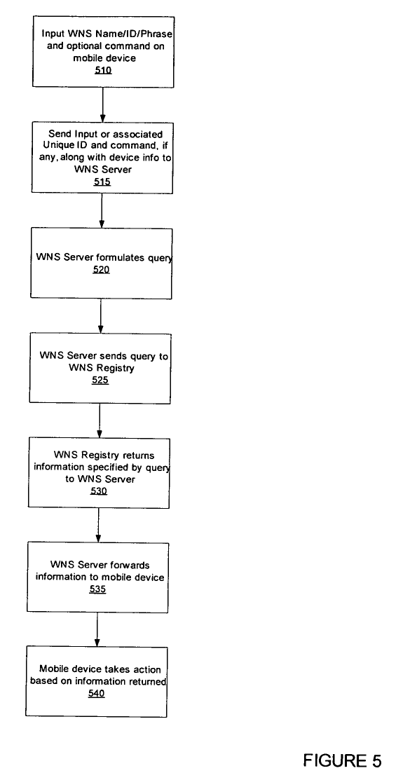

FIG. 5 illustrates a standard WNS call procedure according to at least one embodiment of the invention. First, a WNS Name/ID/phrase and optional command is input on/to the mobile device (block 510). This input may be a voice command, text entry or selection of a name from a list or phone book. The optional command could specify that directions to the location are desired or that the address associated with the WNS name/ID is to be downloaded. As discussed below, the input may even consist of WNS keywords and the like. The Input and/or associated Unique ID and command is sent to the WNS Server along with any additional device information such as the device ID/hone number (block 515). The WNS Server then formulates a query, based on this information, intended for the WNS Registry (block 520). This query is then sent or communicated to the WNS Registry (block 525). The WNS Registry returns information specified by the query to the WNS Server (block 530). This may include the optional application of rules to call circumstances in order to determine what pieces of information are returned. The WNS Server then forwards the information returned it onto the mobile device (block 535). The information may be encrypted, scrambled and/or never displayed, if so configured, on the mobile device. The mobile device takes action based on the information returned (block 540). This action can take the form of placing a call to the number returned by the WNS Server, displaying contact information, such as address, or downloading other data. The action could also be a further query to the user to disambiguate the previous input. For instance, the entry of the word “Pizza” might instead return from the WNS Server two entries, one for “Pizza Hut” and another for “Dominos Pizza” from which the user must select and activate on the mobile device.

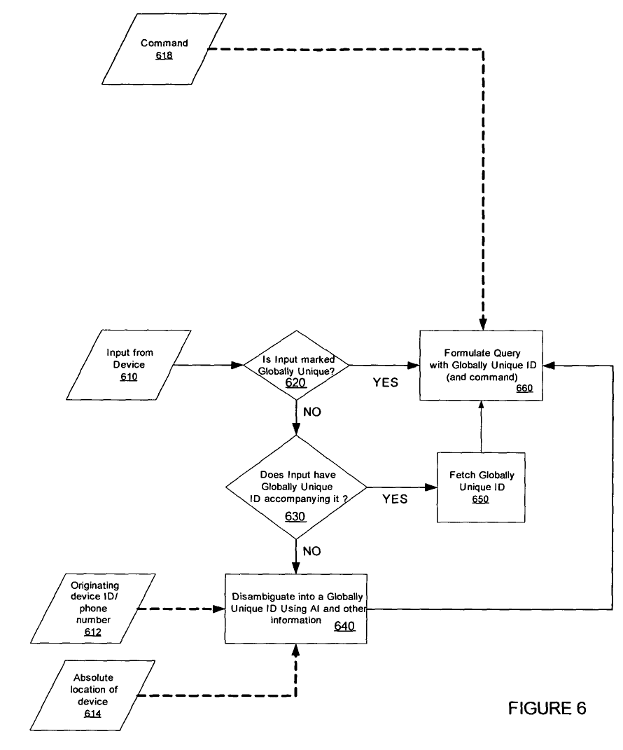

FIG. 6 illustrates WNS query formulation according to at least one embodiment of the invention. The query is formulated primarily from an input 610 from the mobile device. If the input 610 is marked Globally Unique (meaning that it is unique WNS Registry ID) (checked at block 620), then the query is formulated with that unique ID and an optional command 618 (block 660). If the input 610 is not marked Globally Unique, then the Input might have Globally Unique ID accompanying it (for instance, as an embedded data element in the Phone Book entry which provided he input) (checked at block 630). If it does, then the Globally Unique ID is fetched (block 650) and the query is formulated (back to block 660).

If there is no accompanying Globally Unique ID (checked at block 630) then the input can be disambiguated by using other information from the device as well as by using Artificial Intelligence, semantic matching and any number/combination of techniques to disambiguate or match results (block 640). Information such as the originating device ID/phone number 612 and absolute location 614 of the device are examples of common information that might be used in block 640 to disambiguate. Other data such date, time and so on may also be used in disambiguation. Further, when non-unique and Generic names (keywords) are used as input, as described below, disambiguation may mean matching/randomizing results from the WNS Registry which correspond to the keywords.

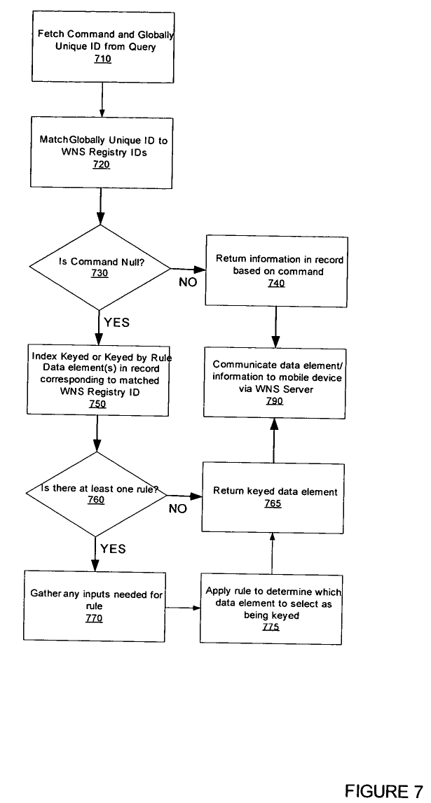

FIG. 7 illustrates indexing into the WNS Registry to return data elements according to one or more embodiments of the invention. The command (if any other than NULL) and the Globally Unique ID is fetched from the query formulated by the WNS Server. The Globally Unique ID is matched to one of the WNS Registry IDs (block 720). In some instances, the Globally Unique ID may not be present in the WNS Registry. This can occur if 1) the WNS Registry had been updated to change a unique ID to some other unique ID, 2) the Globally Unique ID was misspelled, or not completely disambiguated by the WNS Server or 3) the Globally Unique ID was deleted or never created in the WNS Registry. In such cases, either an error message will be returned to the mobile device by the WNS Server or the WNS Server will attempt to match the Globally Unique ID as is to the semantically/phonetically/linguistically “closest” WNS Registry ID. In other embodiments of the invention, the WNS Server performs such closest matching when attempting to form the query itself rather than later, thus guaranteeing a returned result from the WNS Registry or an error message to the mobile device.

If the command is null (checked at block 730) then this indicates that an automatic return of Keyed or Keyed by Rule data element is requested by the mobile device (e.g. a telephone number for dialing). Then, the WNS Server indexes into the WNS Registry record matching the WNS Registry ID to evaluate the Keyed/Keyed by Rule data elements (block 750). If there are no rules then the keyed data element is returned (block 765). This data element is then communicated to the mobile device via the WNS Server (block 790). If the command is not null, then the information in the record is returned based on the command (block 740). This information is then communicated to the mobile device (block 790). Though not depicted in FIG. 7, Command based information may also involve rule resolution. For instance, the address of the closest “Pizza Man” restaurant may involve determining which one is still open at the time of the request.

If there are any rules to resolve, the WNS Server will first gather all of the inputs needed for the rule (block 770), such as the day of the week, date, time or location of the originating call. The WNS Server will then apply the rule to determine which of the data elements will be selected as the keyed data element. The keyed data element is then returned (block 765) and communicated to the mobile device (block 790).

Use of WNS Keywords

WNS Keywords are generic name and phrase instances such as “burgers” or “pizza” which may be input to a mobile device. These are not unique but can be still be resolved into unique results by the WNS Server. This resolution may be based on keywords being bid by potential advertisers and those with the highest bids receiving the greatest probability that that keyword will be matched to them. The resolution may be statistically based or even randomly designated, or may be resolved by location of the mobile device and other matching criteria or artificial intelligence.

In other embodiments of the invention, there may be a plurality of WNS Servers which may be geographically, hierarchically distributed. The WNS Server and Registry architecture is not limited in scope and scope and may use well-mechanisms, as desired, such as load balancing, caching, distributed architectures, switching, etc.

The exemplary embodiments described herein are provided merely to illustrate the principles of the invention and should not be construed as limiting the scope of the invention. Rather, the principles of the invention may be applied to a wide range of systems to achieve the advantages described herein and to achieve other advantages or to satisfy other objectives as well.

What is claimed is:

1. A system for communicating information to a mobile device comprising:
a Wireless Name Service Registry, said registry maintaining a plurality of records, each record corresponding to a unique identifier, each record containing at least one data element;
a Wireless Name Service Server, said Server couple to communicate with said registry, said Server receiving inputs from said mobile device and formulating a query thereby, said query indexing into said registry to return at least one of said at least one data element from said Registry, said returned data elements communicated to said mobile device, wherein said mobile device takes action using said returned data elements.

2. A system according to claim 1 wherein said mobile device is a cellular telephone.

3. A system according to claim 2 wherein said returned data elements include a telephone number.

4. A system according to claim 3 wherein said cellular telephone automatically attempts to connect to the device identified by said telephone number.

5. A system according to claim 1 wherein said Wireless Name Server is configured to resolve rules in order to determine which of said data elements are to be returned to said mobile device.

6. A system according to claim 5 wherein said rules include the consideration of at least one of the time, the date, the identity of the mobile device and the current geographic location of the mobile device.

7. A system according to claim 1 wherein said inputs include at least one a primary input and an optional command.

8. A system according to claim 7 wherein if said primary input does not exactly match a unique ID in said registry, said primary input is disambiguated by said WNS Server.

9. A system according to claim 7 wherein said primary input includes one of a WNS unique ID, an e-mail address, a keyword, a phrase, a place name and a proper name.

10. A system according to claim 7 wherein a NULL command or absence of any command returns keyed data elements from said Registry.

11. A system according to claim 1 wherein said data elements are associated with an access level.

12. A system according to claim 11 wherein said access levels include private, public, keyed, keyed by rule and list.

13. A system according to claim 10 wherein said keyed data elements include a telephone number or other electronic address that said mobile device can connect directly to.

14. A system according to claim 8 wherein said disambiguation includes the consideration of at least one of the time, the date, the identity of the mobile device and the current geographic location of the mobile device

15. A system according to claim 9 wherein if said primary input is a keyword, then the WNS Server can disambiguate said keyword based on priority of owners to such keywords.

16. A system according to claim 1 wherein each record is capable of being associated with at least one of a contact list, white list and black list.

17. A system according to claim 16 wherein said lists can be downloaded to any device or uploaded from any device.

18. A method according to claim 16 wherein said lists may have entries which are linked to other records in said Registry.
